(19) United States
(12) Patent Application Publication
(10) Pub. No.: US 2006/0253673 A1
(43) Pub. Date: Nov. 9, 2006

(54) Apparatus and method for permitting access to storage means

(75) Inventors: Hak-goo Lee, Suwon-si (KR); Sun-woo Kim, Suwon-si (KR); Young-keun Kim, Incheon (KR); Hyun-seok Choi, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/417,144

(22) Filed: May 4, 2006

(30) Foreign Application Priority Data
May 6, 2005 (KR) 2005-38048

(51) Int. Cl. G06F 12/14; G06F 12/00

(52) U.S. Cl. 711/163; 711/203

(57) ABSTRACT

An apparatus and a method for permitting access to storage means are provided in which a host is permitted to easily access a storage means or a plurality of storage means connected to a USB device through a separate interface, as well as an internal flash memory. The apparatus comprises a storage means checking unit to check whether a peripheral is a storage means by referencing received information regarding the peripheral; a virtual storage means generating unit to generate a virtual storage means for the storage means when the checked peripheral is a storage means; a binding unit to bind the storage means and the generated virtual storage means; and a directory generating unit to generate a directory for the bound virtual storage means.

### CROSS-REFERENCE TO RELATED APPLICATIONS

This application claims all benefits accruing under 35 U.S.C. §119 from Korean Patent Application No. 10-2005-0038048 filed on May 6, 2005 in the Korean Intellectual Property Office, the disclosure of which is incorporated by reference herein.

### BACKGROUND OF THE INVENTION

1. Field of the Invention

Aspects of the present invention relate to permission to access storage means, and more particularly, relate to an apparatus and a method for permitting access to storage means whereby a host personal computer (PC) is permitted to easily access a storage means or a plurality of storage means connected to a USB device through a separate interface, as well as an internal flash memory.

2. Related Art

A universal serial bus (USB) is a plug-and-play serial data communications protocol widely used in embedded devices, such as set-to-top boxes, printers, web cameras, digital cameras, personal digital assistants, modems, scanners, mice, keyboards, speakers and zip drives, etc.

Due to its handiness, simplicity, high speed and low cost, the USB has shifted from PC markets to embedded device markets in practice. As a result, there has been a tremendous explosion of all types of USB peripherals providing plug-and-play compatibility and these USB peripherals are becoming industry standard devices.

Typically, a USB system comprises a USB interconnect, a USB host and a USB device. The USB interconnect is responsible for interconnection and communication between a USB host and a USB device, which is implemented by managing USB jobs conducted in each layer of the USB host and the USB device.

A USB host is present in every USB system. Such a USB host can be a host computer system (PC), and is provided with a host controller to control the flow of data in and out of the host PC, and to act as an interface between the host PC and the outside world. The host controller may be composed of combinations of hardware, firmware and software, and is provided with a root hub of the host PC in order to provide one or more attachment points.

USB devices may be hubs or functions. A USB hub provides additional attachment points, whereas a USB function provides such functions as ISDN connections, joysticks, speakers, printers or mass storages, etc.

All the USB devices are participated in the USB system through one or more ports of the USB hub. The USB host receives status bits involved in attachment of a USB device to or detachment of the USB device from the hub and allocates a proper USB address to a newly attached USB device. When the attached USB device is a function, a connection report is processed by host software adaptive to the concerned function.

FIG. 1 illustrates an example architecture and data flow between a USB host and a USB device. In such a USB system, the USB host 10 and the USB device 20 have a function-based hierarchical structure, including a USB bus interface layer 30, a USB device layer 40, and a function layer 30.

A USB bus interface layer 30 provides a packet connection between the USB host 10 and the USB device 20 through a physical and electric signal. At the USB bus interface layer 30, a USB host controller 12 and a USB bus interface 22 are provided at the host 10 and the USB device 20, respectively, for a physical data transmission. A USB device layer 40 is a layer in which USB system software is located to conduct general USB operations for the USB device 20. At the US device layer 40, a USB system software 14 and a USB logical device 24 are provided at the host 10 and the USB device, respectively, for a logical data transmission. A function layer 50 then allows the host 10 to provide additional functions through client software appropriate for the USB device 20. At the function layer 30, a client software 16 and a function driver 26 are provided at the host 10 and the USB device 20 respectively. The USB device layer 40 and the function layer 50 implement logical communications between the host 10 and each layer of the USB device 20, which is actually implemented through data transfers from the USB bus interface layer 30.

The client software 16 for the USB device 20 uses a USB software programming interface to control functions, which is conceptually opposite to direct control of memories or input/output operations, such as peripheral component interconnect (PCI), extended industry standard architecture (EISA) and personal computer memory card international association (PCMCIA) standards.

FIG. 2 illustrates an example technique for a USB host to recognize a storage means of a USB device. As shown in FIG. 2, the USB device 20 may serve as a hub or a function. The hub simply provides additional attachment points, and the function provides proper functions of its own. If a function is to provide a mass storage device including an internal flash memory 220, a USB device 20 can be additionally attached to additional storage means 240, such as a a secure digital (SD) card 240A, a multimedia card (MMCs) 240B, and a memory stick 240N.

The USB device 20 providing computing functions, such as personal digital assistants (PDAs), can access the storage means using a predetermined communication means. When the USB device 20 is connected to the host 10, the host 10 recognizes only the flash memory 220 as a mass storage means. Accordingly, data exchange between the host 10 and the storage means 240 is implemented, via a router (not shown), using a flash memory 220 provided in the USB device 20. As a result, data exchange between a variety of storage means is desirable, as additional storage means 24 as well as an internal flash memory 220 are recognized by the host 20.

Korean Unexamined Patent Publication No. 2004-37708 discloses a method of controlling an internal flash memory installed in a USB device and a storage means additionally connected thereto, using a single USB device driver. A host then recognizes a USB device having a hub chip, and checks for a storage means connected thereto. However, to implement this method, a hub chip, which is a separate hardware unit, needs to be installed in the USB device in advance. In addition, in order to allow a host and a USB device to recognize an additional memory, a communication means between the additional memory and the hub needs to be provided.

### SUMMARY OF THE INVENTION

Several aspects and example embodiments of the present invention advantageously utilize a virtual driver mechanism in a USB device and allow a host to easily access a storage means or a plurality of storage means connected through a separate interface, as well as an internal flash memory of a USB device, using such a virtual driver mechanism installed in a USB device.

Additional aspects and/or advantages of the invention will be set forth in part in the description which follows and, in part, will be obvious from the description, or may be learned by practice of the invention.

In accordance with an embodiment of the present invention, an apparatus of permitting access to a storage means, comprises a storage means checking unit to check whether a peripheral is a storage means by referencing received information on the peripheral; a virtual storage means generating unit to generate a virtual storage means for the storage means when the checked peripheral is a storage means; a binding unit to bind the storage means and the generated virtual storage means; and a directory generating unit to generate a directory for the bound virtual storage means.

In accordance with an embodiment of the present invention, a method of permitting access to a storage means, comprises checking whether a peripheral is a storage means by referencing received information on the peripheral; generating a virtual storage means for the storage means when the checked peripheral is a storage means; binding the storage means to the generated storage means; and generating a directory for the bound virtual storage means.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates an example architecture and data flow between a USB host and a USB device;

FIG. 2 illustrates an example technique for a USB host to recognize a storage means of a USB device;

FIG. 3 illustrates an example device stack installed at a USB device for permitting access to a storage means according to an embodiment of the present invention;

FIG. 4 is a block diagram of an example virtual storage means driver according to an embodiment of the present invention;

FIG. 5 is a flow chart illustrating a process of permitting access to a storage means according to an embodiment of the present invention;

FIG. 6 is a conceptual view illustrating recognition by a host PC of a virtual storage means according to an embodiment of the present invention;

FIG. 7 is a conceptual view illustrating recognition by a host PC of a virtual storage means as having a hierarchical structure according to an embodiment of the present invention; and

FIG. 8 illustrates data exchange between storage means provided according to an embodiment of the present invention.

### DETAILED DESCRIPTION OF EXAMPLE EMBODIMENTS

Reference will now be made in detail to the present embodiments of the present invention, examples of which are illustrated in the accompanying drawings, wherein like reference numerals refer to the like elements throughout. Exemplary embodiments of the present invention will be described in detail with reference to the accompanying drawings.

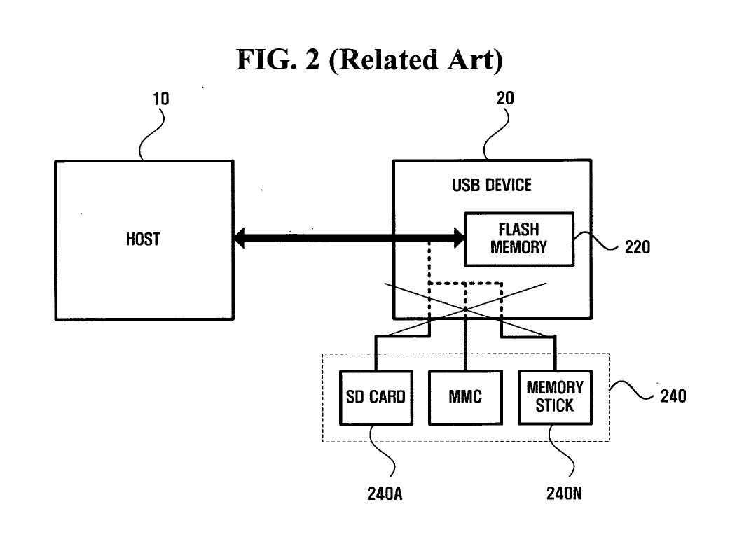

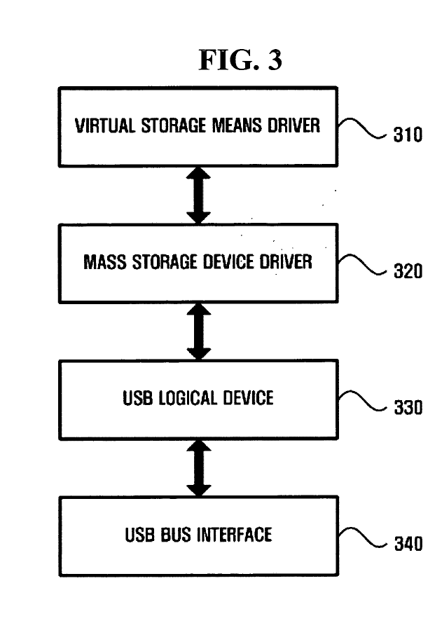

FIG. 3 illustrates an example device stack for permitting access to a storage means according to an embodiment of the present invention. As shown in FIG. 3, the device stack 300 is provided at a USB device 20, as shown, for example, in FIG. 2, comprising a virtual storage means driver 310, a mass storage device driver 320, a USB logical device 330 and a USB bus interface 340. Such a device stack 300 may be utilized to perform functions common to USB device-specific driver, including initialization and configuration, resource management, and data exchange. Such a driver stack 300 can be a software module written using high-level programming languages, such as C, C++, Java, Visual Basic, and may be provided on a machine-readable storage medium, such as a floppy disk or compact disk (CD) ROM, or via Internet downloads, which may be available for a network administrator to conveniently plug-in or download into a host operating system (OS). Such software module may also be bundled with the existing operating system (OS) which may be activated by a particular device driver for automating integration into the host operating system (OS). Alternatively, the driver stack may also be available as a firmware module or a comprehensive hardware/software module which may be built-in a host, i.e., USB device.

The USB bus interface 340 is an element of a USB device 20 in a USB bus interface layer 30, as shown, for example, in FIG. 2, that is packet-connected to a USB host controller 12 in a host 10 through a physical and electric signal.

Various states of the USB device 20 that are recognized by the USB system and the host 10 are: attached, powered, default, address, configuration and suspended states. These states are transmitted by the USB bus interface 340 at the request of the USB host controller. When the USB device 20 has been attached or detached, the USB host 10 conducts confirmation or management of the state of the USB device 20.

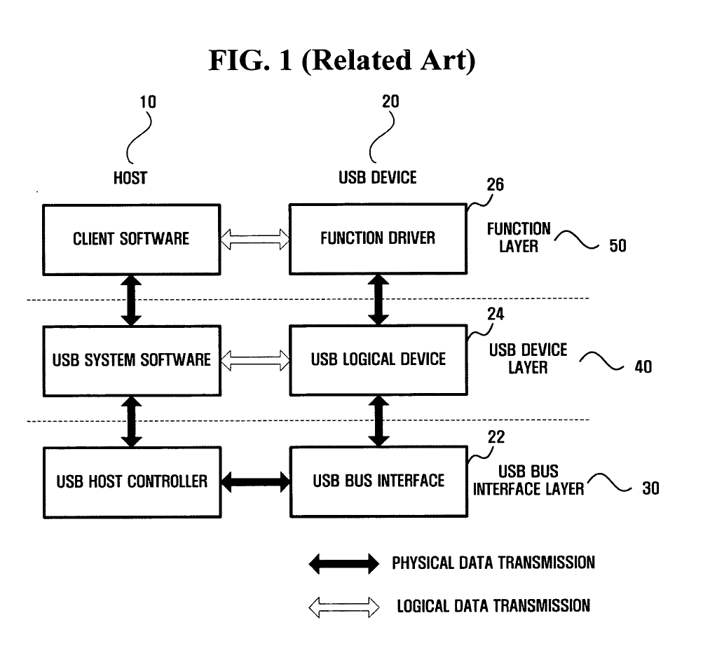

The USB logical device 330 which is an element of the USB device 20 in the USB device layer 40, as shown in FIG. 1, conducts initialization for general USB communications with the host 10 by conducting logical communications with the USB system software 14 of the host 10, and provides an API to a function driver which is an element of the upper function layer 50.

Both the USB logical device 330 and the USB bus interface 340, as shown in FIG. 3, correspond to the USB logical device 24 and the USB bus interface 22 installed at the USB device 20 at the USB device layer 40 and the USB bus interface layer 30, as shown in FIG. 1.

According to an embodiment of the present invention, a mass storage device driver 320 and a virtual storage means driver 310 are installed in a USB device and are implemented to represent a function driver 26 in a functional layer 50, as shown in FIG. 1.

The mass storage device driver 320 provides an API to the virtual storage means driver 310, wherein the API is to conduct communications between the host 10 and USB peripherals such as discs, CD drivers, DVD drivers, thumb drivers, and zip drives.

The mass storage device driver 320 functions as a mass storage interface between an operating system (OS) of the USB device 20 and the host 10. Specifically, the mass storage device driver 320 performs an interface between the virtual storage means driver 310, an element of the upper function layer, and the USB logical device 330.

The mass storage device driver 320 can support command protocols such as a small computer system interface (SCSI), a USB floppy disk interface (UFI) and an advanced technology attachment packet interface (ATAPI).

The virtual storage means driver 310 generates virtual storage means corresponding to a single storage means or a plurality of storage means connected through a separate interface, as well as an internal flash memory, through which the host 10 can conduct data communications with a storage means attached to the USB device 20. The storage means may be one of an internal flash memory, a CF card, an SD card, an XD card, an MMC card and a memory stick. The virtual storage means driver 310 communicates with a driver for the concerned storage means and provides an API that can control the concerned storage means, to the mass storage device driver 320.

File systems used in each storage means may be different. The virtual storage means driver 310 can convert each file system into a file system used in the mass storage device driver 320, that is, a common file system that can be recognized by the host 10.

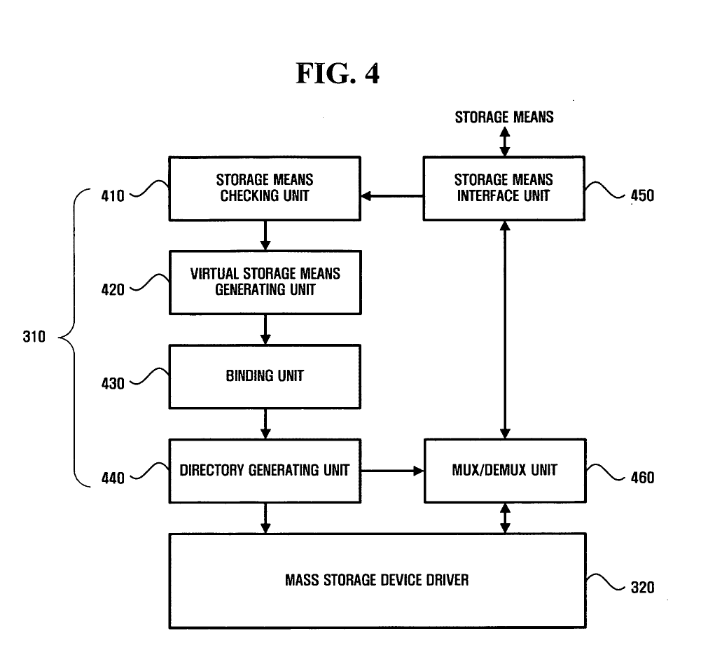

The virtual storage means driver 310 will be described in detail with reference to FIG. 4 herein below.

FIG. 4 is a block diagram illustrating an example virtual storage means driver according to an embodiment of the present invention. The virtual storage means driver 310, as shown in FIG. 3, comprises a storage means checking unit 410, a virtual storage means generating unit 420, a binding unit 430, a directory generating unit 440, a storage means interface unit 450, and a MUX/DEMUX unit 460.

The storage means interface unit 450 receives information on an attached storage means and data stored therein, and transmits the data transmitted from the host 10 to the storage means. Information regarding the storage means is transmitted to the storage means determining unit 410 and data communication with the host 10 is performed through the MUX/DEMUX unit 460.

The storage means checking unit 410 checks whether an attached peripheral is a storage means, by referencing information on the USB peripheral received from the storage means interface unit 450. The attached peripheral includes those devices that provide proper functions without relevance to file input and output, such as printers, web cameras, digital cameras, modems and speakers, as well as the storage means as described above, including a flash memory, a CF card, an SD card, an XD card, an MMC card and a memory stick. The storage means checking unit 410 checks whether a memory free to input and output is provided in the attached peripheral.

Information regarding the USB peripheral may include presence or not of a storage means, the kind and the capacity of the storage means, and a file system used therein.

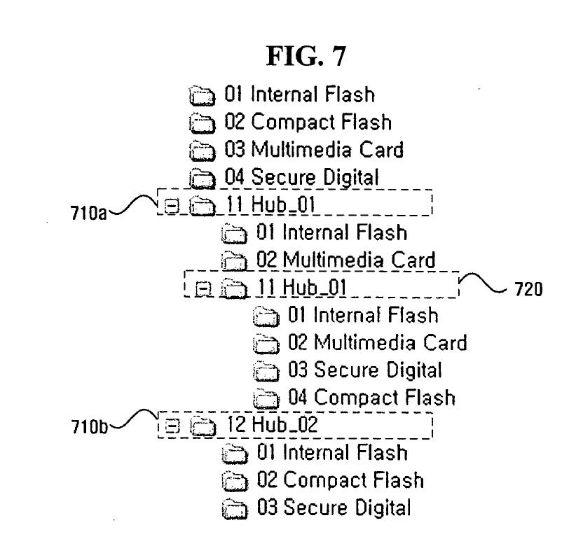

When an apparatus of the present invention has a USB hub (not shown) and a USB device 20 attached to the USB hub (not shown) has a storage means, the storage means checking unit 410 may check to ascertain whether a storage means is indeed attached to the USB hub. The storage means through the USB hub may be generated by the directory generating unit 440 as a directory of a lower layer. The hierarchically structured directory will be described in detail with reference to FIG. 7.

The virtual storage means generating unit 420 generates a virtual storage means corresponding to the storage means checked by the storage means checking unit 410.

When a USB device 20 having an internal flash memory is connected to the host 10, as shown, for example, in FIG. 1, the host 10 accesses the internal flash memory and conducts file input and output. However, the host 10 cannot directly access the storage means separately connected to the USB device 20. To extract and receive the data stored in the separate storage means, the data stored in the separate storage means is transferred to the flash memory by a user and is then received through the flash memory.

The virtual storage means generating unit 420 generates virtual storage means for the internal flash memory and the separate storage means. The generated virtual storage means is recognized by the host 10 as an actual storage means, and accordingly, the host 10 conducts data communications with the internal flash memory and the separate storage means through the generated virtual storage means.

The virtual storage means generated by the virtual storage means generating unit 420 is a software-implemented object, which corresponds to an actual storage means. In other words, the virtual storage means generating unit 420 generates a software object for an actual storage means.

The binding unit 430 binds the actual storage means checked by the storage means checking unit 410 to the virtual storage means generated by the virtual storage means generating unit 420.

When the binding is successfully completed, communications with the host 10 are available. The generated storage means object communicates with the host 10 through pipe objects corresponding thereto. The pipe objects each include a “control” pipe for controls between a host 10 and a USB device 20, an “in” pipe to send data to a host 10 from a USB device 20, and an “out” pipe to send data to a USB device 20 from a host 10. Each pipe may be generated by storage means object.

For reference, configuration refers to an operation to be completed before the USB device 20 performs its function, which is conducted at the request of the host 10. The host requests the USB device to provide configuration data to ascertain performance of the USB device 20. The configuration data includes performance of the USB device 20 and required resources. The host 10 may allocate a USB bandwidth or additionally select a specific function of the USB device 20 through the configuration operation.

The directory generating unit 440 generates a directory for a virtual storage means bound by the binding unit 430.

A file system is a method of attaching a name to a file and representing logical position determination for storage or check. Most of operating systems (OS) have file systems having a hierarchical structure. Accordingly, a file system of a virtual storage means of a USB device 20 recognized by the host 10 is desirably the same as the host 10. The directory generating unit 440 generates a directory of the same file system as the host 10, for the virtual storage means. The generated directory is displayed on the host 10 through the mass storage device driver 320, as shown in FIG. 4.

It is preferable that the directory generated by the directory generating unit 440 is generated per storage means. The user can send data stored in the directory corresponding to each storage means displayed on the host 10 to the host 10 or the data stored in the host 10 to a specific storage means.

A file system proper to each storage means may be stored in the MUX/DEMUX unit 460 or a separate storage unit (not shown). The stored file system of each storage means may be used in converting data received from the host 10 adaptively to the concerned storage means.

The MUX/DEMUX unit 460 conducts file input and output according to a file system used in the generated file directory. In other words, when the data stored in an attached storage means is transmitted to the host 10, the MUX/DEMUX unit 460 converts the data of a specific storage means transmitted from the storage means interface unit 450 into the file system generated by the directory generating unit 440. Also, when the data received from the host 10 is stored in a specific storage means, the MUX/DEMUX unit 460 converts the received data into the file system of the specific storage means.

A file system for each storage means may be stored in the MUX/DEMUX unit 460 or a separate storage unit (not shown).

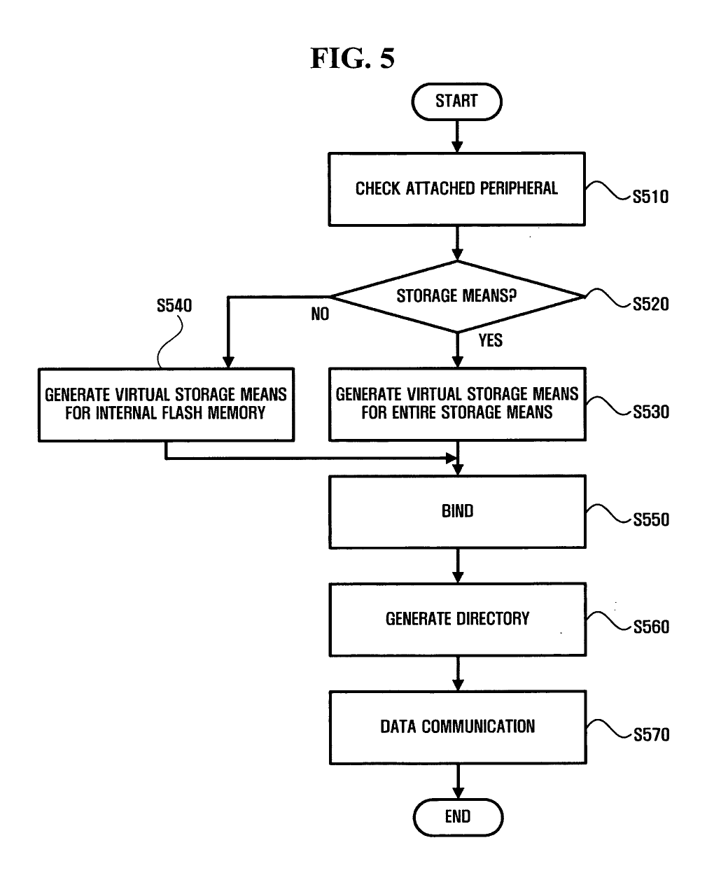

FIG. 5 is a flow chart illustrating a process of permitting access to a storage means according to an embodiment of the present invention.

When a USB device 20 is attached to the host 10, as shown, for example, in FIG. 1, power is supplied to the USB device 20, and hardware and firmware of the USB device 20 are reset. At this time, since a proper address has not yet been assigned to the USB device 20, the USB device 20 responds to the host 10 through a default address. Then, the USB device 20 is allocated the proper USB address from the host 10, receives a control command of the host 10 through a “control” pipe generated using the proper address, and starts the configuration operation according to the control command of the host 10.

The configuration operation should be completed before the USB device 20 performs its function. The host 10 requests the USB device 20 to provide configuration data to ascertain performance of the USB device 20. The configuration data includes performance of the USB device 20 and required resources. The host 10 may allocate a USB bandwidth or additionally select a specific function of the USB device 20 through the configuration operation.

When the configuration operation is completed, the USB device 20 can perform its function according to control command of the host 10.

When power supply and configuration are completed, a peripheral is attached to the USB device 20, and then the storage means interface unit 450, as shown in FIG. 4, receives data from the attached peripheral at operation S510. Referring to the received data, the storage means checking unit 410 checks whether the attached peripheral has a storage means at operation S520. Data received from the attached peripheral may include the presence a storage means, the kind and capacity of the storage means, and a file system used.

The storage means includes a flash memory, a CF card, an SD card, an XD card, an MMC card and a memory stick, and the attached peripheral may be a single peripheral or multiple peripherals.

When the checked peripheral has a storage means, the storage means checking unit 410 transmits information regarding an internal flash memory and information regarding the attached peripheral to the virtual storage means generating unit 420, to allow the virtual storage means generating unit 420 to generate virtual storage means for the internal flash memory and the peripheral storage means at operation S530. When the checked peripheral has no storage means, the virtual storage means generating unit 420 transmits only information regarding the internal flash memory to the virtual storage means generating unit 420, to allow the virtual storage means generating unit 420 to generate a virtual storage means for the internal flash memory at operation S540.

The generated virtual storage means is a software object for the actual storage means. The binding unit 430 binds the virtual storage means object to the actual virtual means so that the host 10 controls the actual storage means through the software object at operation S550.

Once the binding is completed, the directory generating unit 440 generates a directory for the virtual storage means object bound by the binding unit 430 at operation S560.

The directory may use different file systems by system (USB device 20, host 10, storage means). It may not be easy for systems that do not use the same file system to access stored data. Accordingly, it is desirable that a directory of the same file system as that of the host 10 is generated so as to allow the host 10 to easily access the directory for the virtual storage means object. The directory generating unit 440 generates the directory of the same file system as that of the host 10 by storage means.

After generation of the directory, the host 10 and the USB device 20 can conduct data exchange. The MUX/DEMUX unit 460 performs file input and output according to the file system corresponding to the generated directory at operation S570. In other words, when the data stored in an attached storage means is transmitted to the host 10, the MUX/DEMUX unit 460 converts the data of a specific storage means, received from the storage means interface unit 450, into the file system generated by the directory generating unit 440. Also, when the data received from the host 10 is stored in a specific storage means, the MUX/DEMUX unit 460 converts the received data into the file system of the specific storage means.

The file system for each storage means may be stored by the MUX/DEMUX unit 460 or in a separate storage unit (not shown).

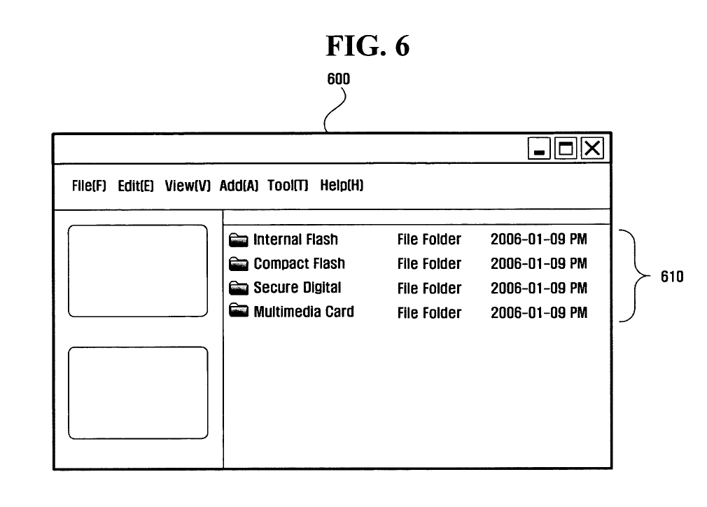

FIG. 6 is a conceptual view illustrating recognition by a host 10 of a virtual storage means according to an example embodiment of the present invention.

A USB device 20 that permits the host 10 to access the storage means according to the present invention is recognized as a mobile disk or a portable disk device. Accordingly, to check the mobile disk or portable disk device, a directory 610 for the internal flash memory or checked storage means can be generated on a display screen 600 as shown in FIG. 6. Therefore, user can find data is stored in the concerned storage means or a lower directory by extending the directory 610.

The name of each directory 610 can be generated by the directory generating unit 440 according to the type of the storage means checked by the storage means checking unit 410, and the user may modify the same on the host 10.

Referring to FIG. 6, each storage means is indicated on a directory basis by the host 10, but it may be indicated by each mobile disk according to a display form. In other words, on the host 10, the directory 610 may include reference to an internal hard disk, a mobile disk for an internal flash memory in the USB device 20, and a mobile disk for a storage means attached to the USB device 20. When the flash memory and the storage means of the USB device 20 are indicated as mobile disks, data stored in each storage means can be stored in the directory structure.

FIG. 7 is a conceptual view illustrating recognition by a host 10 of a virtual storage means as having a hierarchical structure according to an example embodiment of the present invention. As previously described, the internal flash memory of the USB device 20 or a separate storage means attached to the USB device 20 can be indicated as a directory or a mobile disk on the host 10.

The USB device 20 directly attached to the host 10 (hereinafter referred to as a “first USB device”) is provided with a hub. When another USB device (hereinafter referred to as a “second USB device”) is attached to the hub, the directory or mobile disk may be represented as a hierarchical structure. That is, the host 10 provides a visual display of a directory of a storage means, including directories 710a, 710b and 720 for the hub. To check the directories for hubs, directories for the flash memory or storage means provided in the second USB device are displayed as a lower layer.

As shown in FIG. 7, directories 710a and 710b by the first USB device having two hubs and a directory 720 by the second USB device having a hub are generated in a lower layer of the directory 710a by a first hub of the first USB device.

As a directory or a mobile disk with a hierarchical structure is displayed, the user can perform data exchange under the condition that user visually recognizes connection relationships between USB devices.

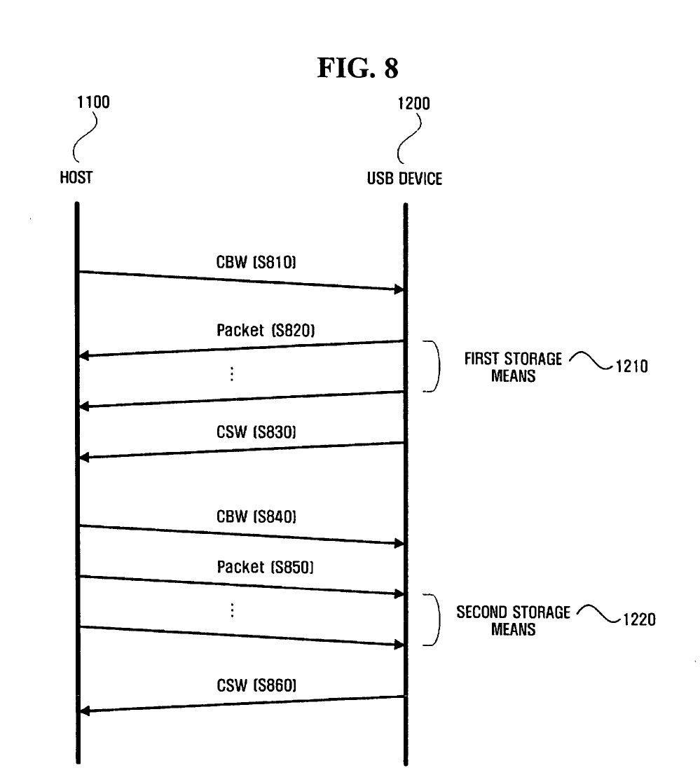

FIG. 8 illustrates data exchange between storage means provided according to an embodiment of the present invention.

After the configurations for address allocation and others are completed, each driver of the USB device 1200 starts to operate. In the USB device 1200 having an internal mass storage device such as a flash memory, the mass storage device driver 320, as shown in FIG. 3 and FIG. 4, employs an advanced technology attachment/advanced technology attachment packet interface (ATA/ATAPI) protocol.

Accordingly, the host 1100 transmits a 31 byte command block wrapper (CBW) to the USB device 1200, wherein an ATAPI command is included in the CBW.

The CBW is a packet transmitted to the USB device 1200 by the host 1100 prior to data exchange. The CBW may include transmission direction and size of data, a logical number of the USB device 1200 receiving the packet, and a control command and the size of the control command to be conducted in the USB device 1200.

In an ATAPI device, the USB device 1200 having received the CBW conducts an operation according to an ATAPI packet control command included in the received CBW. In an ATA device, the USB device 1200 having received the CBW conducts an operation after having converted an ATAPI command included in the received CBW to an ATA command.

When the operation according to the control command is successfully completed, the USB device 1200 transmits to the host 1100 a 13 byte command status wrapper (CSW) to inform this state.

The CSW is a packet transmitted to the host 1100 from the USB device 1200. The CSW may include information on a difference between the size of data included in a CBW and that of the data actually processed, and the completion of a control command, etc.

As described above, data transmission from the host 1100 to the USB device 1200 or from the USB device 1200 to the host 1100 may be conducted through the processes of CBW transmission, data transmission and CSW transmission. These processes may be employed for conducting data exchange between a flash memory of the USB device 1200 and a separately connected storage means. That is, the host 1100 functions as a relay between storage means. When data stored in a first storage means 1210 is transmitted to a second storage means 1220, after having received the data stored in the first storage means 1210, the host 1100 transmits the same to the second storage means.

To receive the data stored in the first storage means 1210, the host 1100 transmits a CBW to the USB device at operation S810. The CBW includes information on transmission direction directed to its own and the concerned data. Accordingly, the USB device 1200 transmits the concerned data packet to the host 1100 at operation S820. Upon completion of the data transmission, the USB device 1200 transmits a CSW indicating the success of the data transmission to the host 1100 at operation S830.

The host 1100 having received the CSW from the USB device 1200 transmits another CBW in order to transmit the received data to the second storage means 1220 at operation S840. This CBW includes information on transmission direction directed to its own and the concerned data. Accordingly, the USB device 1200 receives the data packet transmitted by the host 1100 at operation S850. Upon completion of the data reception, the USB device 1200 transmits another CSW indicating the success of the data reception to the host 1100 at operation S860.

The host 1100 to receive data from the USB device 1100 may have a buffer (not shown) to temporarily store the received data therein. As a buffer (not shown), a hard disk or RAM of the host 1100 may be used.

A user that exchanges data between storage means using the host 1100 may exchange the data with designating the data of a file included in the directory or a mobile disk described in FIGS. 6 and 7. Accordingly, the user conducts data exchange between storage means 1210 and 1220 of the USB device 1200 through a command similar to transmission of the data stored in a directory of the internal disk of the host PC 1100 to another directory.

As described above, an apparatus and a method for permitting access to storage means may have one or more advantages. First, data exchange between storage means is simplified by allowing a host to easily access an internal flash memory or a storage means or a plurality of storage means connected through a separate interface, by installing a virtual driver at the USB device. Second, access to a storage means attached to a USB device is implemented based only on firmware or software, not on hardware, and thus, it can be applied to those products manufactured with existing software products.

Various components of the device stack 300, as shown in FIG. 3, and the virtual storage means driver and the mass storage device driver 320, as shown in FIG. 4, can be implemented in software or hardware, such as, for example, an application specific integrated circuit (ASIC). As such, it is intended that the processes described herein be broadly interpreted as being equivalently performed by software, hardware, or a combination thereof. As previously discussed, software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, both the software modules as described in connection with FIGS. 3-4 can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. An apparatus of permitting access to a storage means, comprising:
a storage means checking unit to check whether a peripheral is a storage means by referencing received information regarding the peripheral;
a virtual storage means generating unit to generate a virtual storage means for the storage means when the checked peripheral is a storage means;
a binding unit to bind the storage means and the generated virtual storage means; and
a directory generating unit to generate a directory for the bound virtual storage means.

2. The apparatus of claim 1, wherein the information regarding the peripheral includes at least one of an indication of the presence of a storage means, a type and capacity of the storage means, and a file system used.

3. The apparatus of claim 1, wherein the storage means includes at least one of a flash memory, a CF card, an SD card, an XD card, an MMC card and a memory stick.

4. The apparatus of claim 1, wherein the generated directory is a logical storage region to use a file system accessible by a host.

5. The apparatus of claim 4, wherein data stored in the at least one storage means is transmitted to another storage means through a buffer provided in the host.

6. The apparatus of claim 1, further comprising a MUX/DEMUX unit to conduct file input and output according to the file system used in the generated directory.

7. A method of permitting access to a storage means, comprising:
checking whether a peripheral is a storage means by referencing received information regarding the peripheral;
generating a virtual storage means for the storage means when the checked peripheral is a storage means;
binding the storage means to the generated storage means; and
generating a directory for the bound virtual storage means.

8. The method of claim 7, wherein information regarding the peripheral includes at least one of an indication of the presence of a storage means, a type and capacity of the storage means, and a file system used.

9. The method of claim 7, wherein the storage means includes at least one of a flash memory, a CF card, an SD card, an XD card, an MMC card and a memory stick.

10. The method of claim 7, wherein the generated directory is a logical storage region to use a file system accessible by a host.

11. The method of claim 10, wherein data stored in the at least one storage means is transmitted to another storage means through a buffer provided in the host.

12. The method of claim 7, further comprising a MUX/DEMUX unit to conduct file input and output according to the file system used in the generated directory.

13. A USB system comprising:
a host; and
a USB apparatus connected to the host, via a port, the USB apparatus comprising an internal memory device, an operating system (OS) and a device stack configured to permit access to the internal memory device and a peripheral coupled to the USB device,
wherein the device stack comprises a bus interface to provide physical data communications with the host; a mass storage device driver to control access to the internal memory device; and a virtual storage device driver to control access to the peripheral coupled to the USB device.

14. The USB system of claim 13, wherein the virtual storage device driver comprises:
a storage device checking unit to check whether the peripheral is an external memory device based on information received regarding the peripheral;
a virtual storage device generating unit to generate a virtual storage device when the peripheral is an external memory device;
a binding unit to bind the external memory device and the virtual storage device; and
a directory generating unit to generate a directory for the bound virtual storage device.

15. The USB system of claim 14, wherein the information regarding the peripheral includes at least one of an indication of the presence of an external memory device, a type and capacity of the external memory device, and a file system used.

16. The USB system of claim 14, wherein the external memory device corresponds to one of a flash memory, a CF card, an SD card, an XD card, an MMC card and a memory stick.

17. The USB system of claim 14, wherein the directory is a logical storage region to use a file system accessible by the host.

18. The USB system of claim 14, wherein data stored in the external memory device is transmitted to the internal memory device, via a buffer provided in the host.

19. The USB system of claim 14, further comprising a MUX/DEMUX unit to conduct file input and output according to the file system used in the directory.

20. The USB system of claim 14, wherein the device stack is a software module written using a high-level programming language, and is provided on a machine-readable storage medium for a plug-in or download into the operating system (OS).
